(19) United States
(12) Patent Application Publication
(10) Pub. No.: US 2013/0071306 A1
(43) Pub. Date: Mar. 21, 2013

(54) Battery disposal system

(71) Applicants: John Camp, Rockport, TX (US); David M. Camp, Cypress, TX (US)

(72) Inventors: John Camp, Rockport, TX (US); David M. Camp, Cypress, TX (US)

(21) Appl. No.: 13/587,815

(22) Filed: Aug. 16, 2012

Related U.S. Application Data
(60) Provisional application No. 61/523,963, filed on Aug. 16, 2011.

(51) Int. Cl. A62D 3/32; C22B 26/12; C22B 7/00

(52) U.S. Cl. CPC A62D 3/32; C22B 7/00; C22B 26/12
USPC 423/179.5; 423/1; 588/314; 75/414; 75/708; 75/10.14

(57) ABSTRACT

Embodiments described herein comprise a system and method for the recycling and recovery of components and metals found within lithium ion batteries. The process includes the safe and effective means of disposing of batteries, including lithium thylnel cloride, lithium ion, conventional designs, in a manner that utilizes a process of alloying to chemically capture the by product.

### CROSS-REFERENCE TO RELATED APPLICATION

This application claims priority benefit of U.S. provisional patent application No. 61/523,963, titled “Battery Disposal System” filed Aug. 16, 2011 with the inventor John D. Camp and David Camp. This related application is hereby incorporated by reference in its entirety.

### FIELD OF USE

Recycling and recovery of resources found within portable energy storage devices.

### BACKGROUND

Lithium batteries of varying types have been used in many applications as a source of long lived remote power. As the batteries become discharged, or have their charges drop below usable levels, the need for their disposal arises and this need has created the requirement of a safe, dependable and economical method for the destruction and recycling of their components. Because of the hazardous and explosive nature of the components of these batteries their disposal has been problematic. With the expansion of use of these sources of electrical energy this need is increasing and the number of batteries currently requiring disposal, and or recovery of the various elements within, is growing rapidly.

The disposal of lithium batteries can be hazardous due to the high reactivity of their components. The destruction of the battery can lead to explosive releases of energy, fires and the discharge of toxic and corrosive gases. Thionyl chloride combines readily with moisture to form hydrochloric and sulfuric acid. Other lithium batteries may produce cyanide compounds upon rupture. Lithium, when exposed to moisture, will release hydrogen which can form explosive mixes with oxygen. Subsequently, destruction methods have focused on capture of these gases during the rupturing of the battery or the retarding of the reactions by lowering the battery to very low temperatures using liquid gases. A prior technique for destruction disclosed in U.S. Pat. No. 4,637,928 utilizes a submerged hammer mill in an explosion proof container designed to capture the released gases and resulting explosive components. This invention offers the advantage of feeding the batteries directly to the system without their being discharged or disassembled. The water used to submerge the hammer mill reacts with the exposed lithium explosively and the thionyl chloride forms hydrochloric and sulfuric acid clouds inside the container which can lead to hazardous discharges and the potential for toxic leakage. Techniques and equipment disclosed in U.S. Pat. No. 5,523,516 utilize a series of steps which include the complete discharge of the battery, possibly cooling the battery while discharging, and disassembly of the battery involving the removal of the case. Utilizing liquid gases such as nitrogen or argon to lower the temperature of the battery below the temperature at which further the reactions will generally occur, cutting the battery into pieces and feeding these pieces into an incinerator. An alkaline scrubber is used to scrub exit gases from the incinerator and the alkaline wash is mixed with scrap metals and other materials discharged from the incinerator to complete the reactions. The wash water precipitates remaining heavy metals and the discharge water is pH adjusted prior to discharge.

There is a need for a simple, direct and economical process which will allow the safe and controlled destruction of lithium cells which avoids both the potential for toxic release, the reduction of safety hazards and fire danger associated with storage and accidental explosive discharge of these batteries and also allows for the recovery of materials utilized in the battery construction.

### SUMMARY

The present invention allows the safe disposal of electrical batteries, particularly lithium thionyl chloride cells specifically but not limited to the type used in down hole drilling operations. The process occurs in an automatic and sequential fashion requiring only that the batteries be fed, as received, into the invention after which the batteries are automatically and rapidly shorted and fed under the surface of a molten metal, or metal alloy bath and retained at a temperature sufficient to maintain the bath above the melting point of the metal or alloys and in intimate contact with the molten metal for a period of time sufficient to completely destroy the battery and its hazardous components and allow all of its metal components to alloy into the metal bath. It is specifically intended in the process described to short the battery, either by scoring, piercing, cutting, etc. It is commonly known by those in industry that the damage to the battery cell may initiate an internal short resulting in rapid degradation and potential and rapid discharge of energy. The high speed shorting process minimizes this inherent risk.

The high speed shorting process which could consists of impact puncturing, saw blade cutting, or any other means of mechanically piercing the battery pack shell and housing, is designed to provided an immediate short of the battery and to relieve the battery to prevent rapid energy expansion. The high speed shorting system may consists of machined rollers and counter rotating, symmetrically opposed square shouldered blades which puncture the battery casing along its opposing sides at a high rate of speed. Whereby when the battery is inserted into the roller blade configuration a series of longitudinal holes are created in the battery at some predetermined degree offset in relation to the circumference of the battery.

In furtherance, there are instances in which the batteries are packaged into multi-cell packs contained within an additional housing such as elongated fiberglass tubes. In this case a deviation from the process may be required due to the housing. Using the mentioned high speed shorting system the battery packs are punctured/pierced and the individual batteries shorted, then the pack is immediately injected in to a chemical bath. The pierced battery within the battery pack immediately begins to release thionyl chloride, sulfur dioxide and lithium chloride, however the speed of the piercing device prevents any significant escape of the vapor prior to immersion in the bath. Once the battery pack is injected into the bath, the bath is monitored and balanced to a specific pH level that is basic in nature and maintained through regulated injection of materials to maintain the desired pH, such as the use of sodium hydroxide. The enclosure surrounding the piercer is attached to the inlet of a blower which, in turn covers the entire bath. Collected vapor from the piercer along with any vapor from the bath itself is captured by this blower and injected at high pressure into a series of headers which line the bottom of the neutralized water bath. Any gases generated which are not immediately dissolved in the bath are re-circulated in this manner through the bath and are dissolved, thus preventing any discharge. These gaseous components are highly soluble in water. The dissolution of these materials in water creates hydrochloric and sulfuric acid. The automatic feed of sodium hydroxide into the bath neutralizes these acids. The battery packs, with enclosed batteries are maintained in the bath until such time as they are removed from the bath for injection into the previously mentioned molten alloy bath.

Once removed from the gas collection bath, the external fiberglass housing of the battery packs are removed mechanically and stockpiled for recycling or recovery at a later date.

Battery cells are injected into the molten alloy bath in whole, or in part by cutting the cells open via any number of methods. Cells may either be injected directly from the high speed shorting system, or via some other feed system post gas collection bath.

The batteries are fed into molten alloy bath which is composed of an aluminum alloy composition that can be altered as necessary for minor compositional changes of the components being injected. The aluminum alloy is heated to approximately 1500 deg F., which thereby leaches and alloys the lithium from lithium hydroxide and lithium chloride and residual lithium metal contained in the depleted battery. Carbon from the cell is bound in the aluminum slag as are components, such as nickel from the stainless steel. Any elements that are not bound into the aluminum alloy bath are removed as slag and oxidized by product and are then containerized for further recycling.

Discharged energy from the battery and recombinant (heat of formation) energy from the formation of metal salts are used in the invention to contribute to the energy balance of the system and dramatically reduce the fuel requirements necessary to maintain the described molten metal at the prescribed temperature. Plastic components are reduced to carbon in the bath and inorganic materials will generally form metal salts. Any remaining materials are captured in solution in the molten metal bath. Typical high enthalpy chemical reactions, ΔH°=Σ(v×ΔH_{f}°) (products)−Σ(v×ΔH_{f}°) (reactants), included in the process are:

4Al+3O₂→2Al₂O₃

Mg+O→MgO

Zn+O→ZnO

Al+3Cl→AlCl₃ and the alkali choloraluminates such as Al₂Cl₆

Mg+Cl₂→MgCl₂

Zn+Cl₂→ZnCl₂

Associated salt formation through the formula 2Al+3X₂→2AlX₃ (X=Cl, Br and I) where the Aluminum may be another reactive metal of claim 1

2Al+3S→Al₂S₃

The formation of metal sulfates such as Al₂(SO₄)₃, MgSO₄

The formation of metal sulfides such as 2Li+S→Li₂S

Zn²⁺+S²⁻→ZnS

The formation of hydrides such as lithium hydride and lithium aluminum hydride and the subsequent generation of reactive aluminum hydride and free hydrogen which is utilized in the energy balance of the invention.

2Li+H₂→2LiH

LiH+H₂O→LiOH+H₂

LiAlH₄+4H₂O→LiOH+Al(OH)₃+4H₂

2LiAlH₄+ZnCl₂→2AlH₃+2LiCl+ZnH₂

A small wet scrubber may be utilized to scrub exit gases for the removal of carbon in instances where high level of plastics are employed in the manufacture of the disposed batteries.

At the point at which the aluminum alloy bath becomes saturated with higher melting point alloys, the aluminum alloy bath is poured into ingots of metal and metal slag containing metals and salts formed in the aluminum alloy bath, then collected from the system and can be sold for metal component recovery, thereby recovering valuable materials that would otherwise be lost.

This process provides for the safe, economical and environmentally impact free disposal of these problematic batteries and recovers valuable materials that would otherwise be lost.

### BRIEF DESCRIPTION OF THE DRAWING

These and other features, aspects and advantages of the present invention will become better understood with reference to the following description, and accompanying drawing, where:

FIG. 1 is a schematic diagram showing the flow of materials through a first process.

FIG. 2 is a schematic diagram showing the flow of materials through a second process.

FIG. 3 is a layout drawing a high speed shorting/venting system to receive specific battery shapes.

### DETAILED DESCRIPTION OF DRAWING

The primary objective of the invention is to allow the destruction of an energy storage battery containing hazardous materials without creating a hazard and to produce non-hazardous waste products which can be safely and easily be recycled or disposed. This invention is of general application to lithium batteries of varying types but specifically batteries used in down hole drilling operations.

The present invention is primarily designed for the disposal of batteries with cells composed of a lithium metal anode and a liquid thionyl chloride electrolyte. However, it is also applicable to all other lithium battery compositions, or batteries utilizing other hazardous anode, cathode and electrolyte combinations such as nickel/metal hydride or sodium/sulfur sodium/nickel batteries.

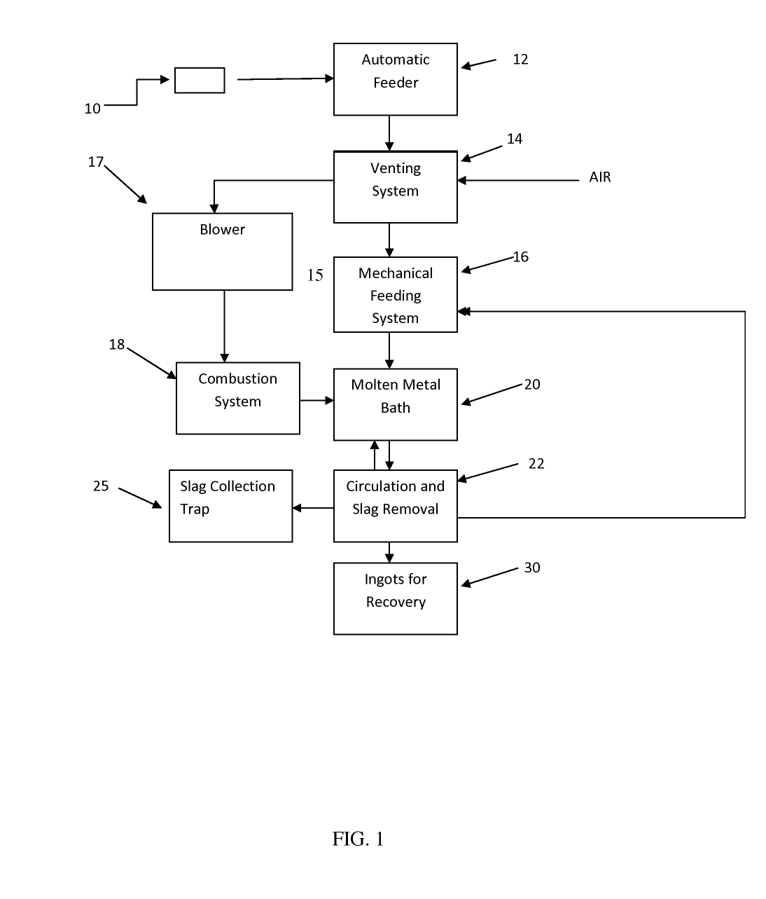

In a preferred embodiment of this invention (FIG. 1), the process flow is such that a battery 10 is introduced into an automatic feeder 12 which accepts the battery and closes once the battery is engaged, closing the battery off from the surrounding environment.

In many expended lithium batteries the lithium metal will have been substantially consumed in the battery reactions. In some batteries, however, this is not the case and expended batteries may contain excess lithium. These batteries will be more energetic. The automatic feeder 12 seals the battery into the systems to remove all possibility of gas leakage when feeding.

The automatic feeder system operates in similar manner to a breach in which the battery is loaded and the breech is closed. Once closed the battery is isolated in the system. The automatic feeder will then push the battery forward where it is automatically picked up by a high speed shorting/venting system 14.

The venting system 14 effectively punctures the battery casing at a high rate of speed and force it forward into a mechanical feed system 16. The mechanical feed system 16 then submerges the venting battery beneath the surface of a molten metal bath 20. The punctured and venting battery adds energy and recombinant heat to the molten metal bath 20. The venting system 14 is constantly purged by suction air from a blower 17 used for the combustion system 18. Any gases which remain in the venting system 14 are purged into the combustion system 18 after being blended with ambient air from the blower 17.

The battery is maintained in the molten metal bath 20 for a retention period sufficient to allow for complete destruction of the battery and resulting alloying of the metallic components of the battery. Circulation in the molten metal bath 20 is maintained by combination of the mechanical feed system 16, expanding gases from the disintegrating batteries, and periodic manual or automatic slag removal.

Liquid metal recirculates to the slag removal system 22 where slag is mechanically removed from the system by a ceramic or suitably coated auger. Slag discharges through slag collection water trap 25 to maintain system integrity.

Ingots are periodically removed from the system 30, for recovery and recycling of metals, found in the batteries, that have been alloyed during the retention period.

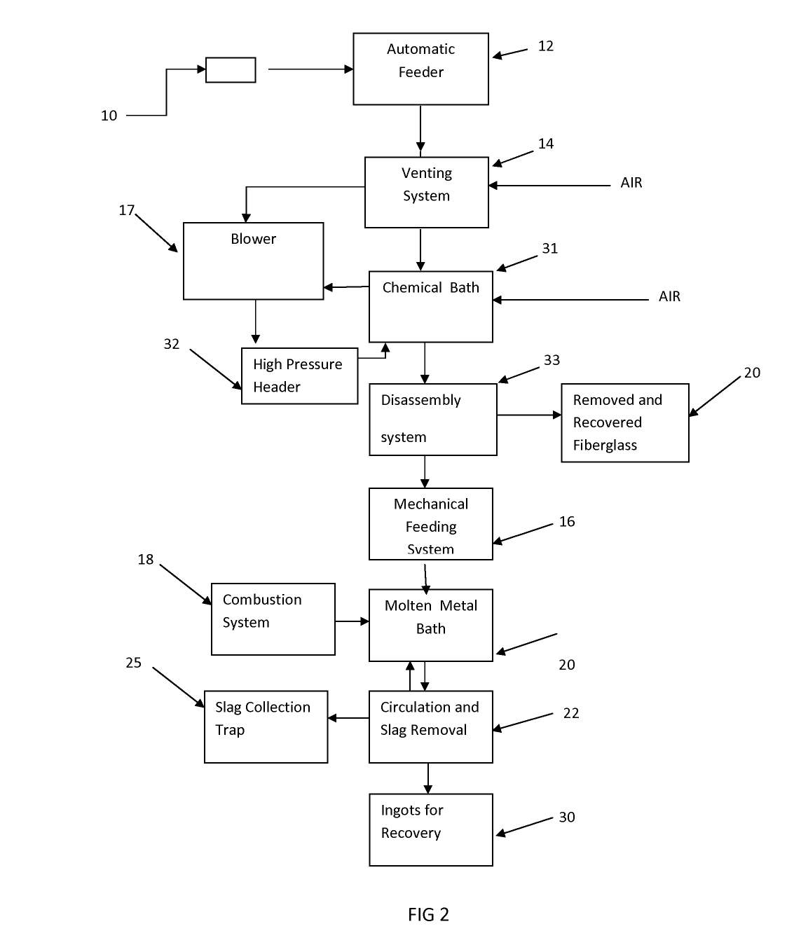

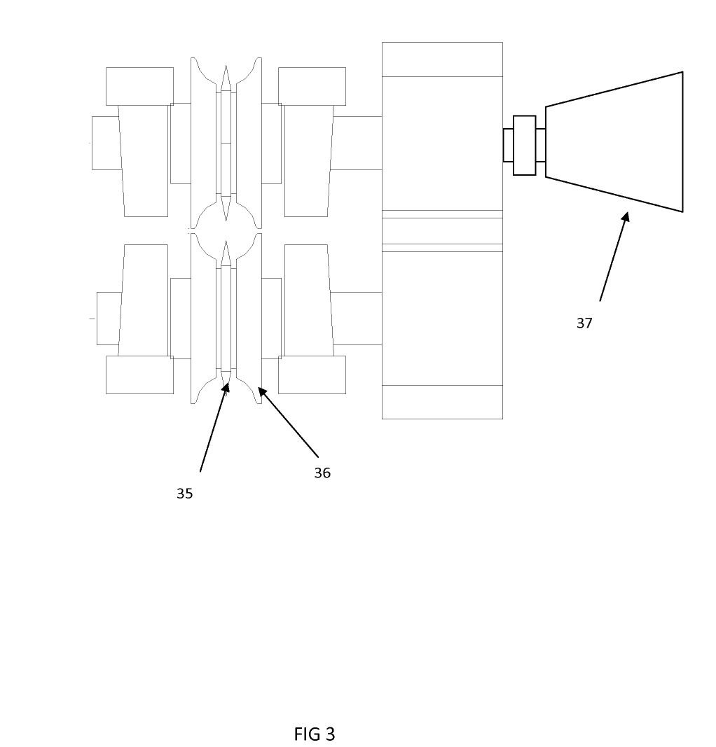

In an alternate embodiment of the invention (FIG. 2) the process flow is such that that a battery 10 is introduced into said automatic feeder system 12 and is introduced into said venting system 14. The high speed shorting/venting system is further described in FIG. 3

The venting system 14 effectively punctures the battery casing at a high rate of speed and force it directly into a chemical bath 31. The venting system 14 is constantly purged by suction air from a recirculating blower 17. The chemical bath is constructed with a gas collection hood above. The gases that escape from the chemical bath along with any gases which remain in the venting system 14 are captured and purged by suction air from the recirculating blower 17, then discharged into gas headers 32 located in the chemical bath 16 and subsequently dissolved.

The battery is fed from the chemical bath either (1) directly into the mechanical feed system 16 which immediately submerges the battery beneath the surface of the molten metal bath 20 or (2) in the case of multi-cell batteries encased in fiberglass, into a disassembly unit 33 for the removal of the outer fiberglass shell. Then the remaining battery components are fed into the mechanical feeder 16 which immediately submerges the battery beneath the surface of the molten metal bath 20.

The battery is maintained in the molten metal bath 20 for a retention period sufficient to allow for complete destruction of the battery and resulting alloying of the metallic components of the battery. Circulation in the molten metal bath 20 is maintained by combination of the feed system 16, expanding gases from the disintegrating batteries, and periodic manual or automatic slag removal.

Liquid metal recirculates to the slag removal system 22 where slag is mechanically removed from the system by a ceramic or suitably coated auger. Slag discharges through slag collection water trap 25 to maintain system integrity.

Ingots are periodically removed from the system 30, for recovery and recycling of metals, found in the batteries, that have been alloyed during the retention period.

FIG. 3 illustrates one variation of the high speed shorting/venting system. The venting system (FIG. 3), contains predetermined blades or puncturing devices 35 and rollers 36 designed specifically for the battery shape, allowing the blades or puncturing devices to introduce holes. The said blades 35 and their corresponding rollers 36, are continuously rotating via a driven means 37.

Although the present invention has been described alternate details with references to preferred versions and uses thereof, other versions and uses are possible. For example, the procedure is not limited to lithium/thionyl chloride or other lithium based batteries but is also usable for disposal of other types of batteries or compositions which may create hazards or toxic materials on disposal. Therefore, the appended claims should not be limited to the description of the preferred embodiments of the invention described herein.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A process for the safe destruction and recycling electrical storage batteries having at least one cell comprising the steps of:
a rapid and safe mechanical shorting of the a battery;
a rapid injection of the shorted battery beneath a molten surface of low melting point alkaline, alkali, transitional metals or other metals and metal alloys at a temperature necessary to maintain a molten state of said metals or metal alloys, and;
utilization of the discharge energy and recombinant energy of the resulting reactions to provide sustaining energy to the molten metal or alloy, and;
extracting the recoverable metals of said battery from resultant alloy and any sublimed carbon or salts for disposal or recovery.

2. The process of claim 1 wherein the step of shorting of the battery is conducted in a shielded purged chamber utilizing high speed blades, punches or other mechanical means to both short and feed the battery into said molten metal or alloy maintained at the temperature necessary to maintain a molten state of said metal or alloy.

3. The process of claim 1 wherein the step of shorting of the battery is conducted in a shielded purged chamber utilizing rollers that include a means of damaging teeth, blades, or protrusions prescribed on the outside diameter, with said roller mounted in a generally perpendicular fashion to the feed direction of said storage battery, and driven at circumferential speed rates required for the desired feed rate of said batteries being delivered into said molten metal or alloy.

4. The process of claim 3 further including the purging of the chamber in which the shorting of the battery is conducted with a mixture of flue gases, inert gases other than nitrogen and ambient air and the introduction of these gases, including any entrained gaseous materials, into a combustion heating system for destruction.

5. The process of claim 3 further including the purging of the chamber in which the shorting of the battery is conducted with inspirated ambient air and the introduction of these gases including any entrained gaseous materials into a neutralizing bath for dissolution.

6. The process of claim 1 further including the step of rapidly submerging the shorted battery beneath the surface of said molten metal or alloy at a feed point utilizing a liquid metal vortex, created by a rapidly rotating hollow impeller specifically designed to create said vortex or a non-contacting electro-magnetic pump specifically oriented to create said vortex collecting and separating gaseous, molten and solid material discharged from the purged shorting chamber or other such device as may be employed to insure the submergence of the shorted battery such as spacers placed in the feed line of the batteries to insure submergence of the shorted battery beneath the surface of said molten metal or alloy.

7. The process of claim 1 further including the step of submitting said shorted battery beneath the surface of a chemical bath prior to said rapid injection into said molten metal or alloy, thereby allowing gaseous venting of said shorted battery into said chemical bath and utilizing a mechanical means of circulating gases from bath into header located in said bath, for some period of time so as to allow gases to be absorbed into said chemical bath.

8. The process of claim 7 further including the removal of said batteries from said chemical bath and introducing said batteries to mechanical means to remove outer housing of said batteries prior to introducing to molten metal bath or alloy.

9. The process of claim 3 further including the step of delivering the shorted battery beneath a baffle submerged in said molten metal or alloy preventing the battery from returning to the surface of said molten metal or alloy.

10. The process of claim 4 further including the utilization of the energy of recovered and entrained gases from the purging of the said chamber in which the battery is shorted or cut for outer shell removal to add to the overall energy demand of the system by the addition of these gases to the heating system of the invention and the destruction of said entrained gases through incineration and the maintenance of said entrained materials at adequate residence time and temperature to insure their destruction through incineration.

11. The process of claim 1 further including the incorporation of said recoverable metals, through melting and alloying, from the structure of the shorted battery into said molten metal or alloy and the utilization of those incorporated metals in the process.

12. The process of claim 9 further including the utilization of the discharge energy of the submerged battery, and all exothermic reactions involved in the egradation of the submerged battery including the recombinant energy of the formation of various materials and resulting reactions in the molten metal to help sustain the temperature of the molten metal of claim 1 above its melting point.

13. The process of claim 3 further including the step of re-circulating the molten metal back to the feed point of claim 5 utilizing the force of said mechanical feed, discharge energy and recombinant energy of the battery injected into the molten bath, and mechanical driving of the molten metal to increase exposure of the battery to fresh molten metal and increase mass transfer of the system.

14. The process of claim 6 further including the mechanical extraction of salts and slag from the molten metal, by the combined use of a mechanical driving mechanism for the circulation of the molten metal and the simultaneous removal of slag for its recovery or disposal, prior to the reentry of the re-circulated molten metal into said vortex and or said feed point.

15. The process of claim 11 further including the constant or intermittent removal and cooling of metal alloy ingots for metal recovery and or solid waste disposal as said molten metal or alloy bath continues to fill during feeding operations through the incorporation of said recoverable metals.

16. The process of claim 1 wherein the electric batteries contain lithium/thionyl chloride cells.

17. The process of claim 1 wherein the electric batteries are submerged the molten metal described in claim 1 at a temperature in excess of the melting point of such metal mixture.

18. The process of claim 1 wherein the alkaline metal, alkali metal, transition metals or other metal is selected from a group consisting of, or alloy of Lithium, Aluminum, Magnesium, Zinc, Iron, Nickel, Copper, Tin, Lead, Zinc and Calcium.

19. A process for the safe disposal and recycling of electrical storage batteries, and specifically those batteries used in down hole drilling applications, having at least one cell comprising the steps of:
mechanically shorting said battery by piercing, slicing or otherwise damaging its structure, in a purged feed chamber, and the utilization and destruction of the purge gas through incineration in the gas fired section of the invention, or separately in embodiments of the invention systems utilizing other sources of heat such as immersion tubes, or induction.
submerging said battery into molten metal consisting of a varying combination of metals or alloysat a temperature sufficient to maintain said metals or alloys in the molten state,
utilizing the discharge, reaction and recombinant energy released by said battery in the molten metal as a fuel for the process of destruction and recycling of the battery,
feeding said battery into a vortex of molten metal or metal alloy through a vortex specifically arranged for this purpose or through an appropriate feed mechanism to insure maintained submergence of the shorted battery,
maintaining said battery in said molten metal at a temperature sufficient to maintain said molten metal in its molted state for a sufficient residence time to allow for complete destruction of said battery components through pyrolysis, incineration, chemical interactions and alloying of metallic components into the molten metal,
removal and recovery of slag and salts while mechanically driving the recirculation of the molten metal or metal alloy through the use of a specifically designed impeller,
removal and cooling of ingots, continuously or intermittently for recycling of recoverable metals found in said battery, or non-hazardous solid waste disposal

20. The process of claim 19 wherein said battery is introduced to a chemical bath containing a vent hood and recirculating blower that recirculates captured gases, resulting from said battery, into said chemical bath for some retention time to allow for absorption of said gases.

21. The process of claim 20 wherein said battery is removed from said chemical bath and introduced to a mechanical means of removing outer shell prior to submerging into said molten metal.

22. A process for the disposal and recycling of a battery having components which can be hazardous and/or explosive and which can otherwise create a hazardous reaction upon destruction comprising the steps of:
a high speed shorting of the battery in a manner which precludes the excessive buildup of internal pressure within the battery and feeding of the shorted battery beneath the level of a molten metal or other metal alloys contained in a suitable chamber at a temperature sufficient to maintain the metal or metal alloy in a molten state and;
rapid submerging of the shorted battery through the means of a specially designed feed point and/or mechanical injector into the molten metal or metal alloy;
holding the shorted battery beneath the surface of the molten metal or metal alloy for a sufficient residence time to allow for complete destruction and recombination or alloying or recovery of all components of the shorted battery and the utilization of the discharge energy, reaction energy and recombinant energy, by the process, through the use of this energy to maintain the molten metal or metal alloy above its melting point, and;
removing and cooling metal ingots containing the previously molten metal and metal alloy for metal recovery or non-hazardous solid waste disposal;

23. The process of claim 22 wherein the battery is a lithium battery.

24. The process of claim 23 wherein the battery is a potentially explosive device.
